(19) United States
(12) Patent Application Publication
(10) Pub. No.: US 2023/0025485 A1
(43) Pub. Date: Jan. 26, 2023

(54) LOW-VISCOSITY LIQUID DETERGENT COMPOSITION COMPRISING ANTIFOAM AND NON-IONIC SURFACTANT

(71) Applicant: The Procter & Gamble Company, Cincinnati, OH (US)

(72) Inventors: Haiyan HUANG, BEIJING (CN); Yang XU, BEIJING (CN); Yijia Cao, BEIJING (CN)

(21) Appl. No.: 17/857,287

(22) Filed: Jul. 5, 2022

(30) Foreign Application Priority Data
Jul. 8, 2021 (CN) PCT/CN2021/105166

(51) Int. Cl. C11D 1/83; C11D 3/00; C11D 3/48; C11D 3/12; C11D 3/382; C11D 3/37; C11D 3/20; C11D 11/00

(52) U.S. Cl. CPC C11D 1/83; C11D 3/0026; C11D 3/48; C11D 3/124; C11D 3/382; C11D 3/373; C11D 3/2086; C11D 3/2068; C11D 11/0017; C11D 1/72

(57) ABSTRACT

A low-viscosity liquid detergent composition comprising an antifoam and a non-ionic surfactant.

### FIELD OF THE INVENTION

The present invention relates to a low-viscosity liquid detergent composition comprising an antifoam and a non-ionic surfactant.

### BACKGROUND OF THE INVENTION

As detergent products are evolving, consumer needs in the term of cleaning have been well met. Then, in addition to cleaning performances, consumers are expecting some other benefits.

For example, in some regions, consumers prefer liquid detergent products which have low viscosity and low suds. Consumers in these regions believe high viscosity corresponds to “messy” and difficult to manipulate. So low viscosity is highly desirable. Further, low suds performance is preferred for machine wash users because high suds might cause more water and more time for rinse.

However, these two benefits are somewhat conflicting because antifoams which are commonly used in liquid detergent compositions (e.g. silicone) are highly viscous. As such, in the presence of the antifoam, it is very challenging to provide a low-viscosity liquid detergent composition. Furthermore, the addition of antifoam might compromise the stability of liquid detergent compositions, resulting in phase separation and/or flocculation. In this case, it some cases, it might be necessary to further include a stabilizing agent which might further increase the viscosity. The addition of such stabilizing agent might further increase the viscosity.

Thus, there is a need for low-viscosity liquid detergent compositions comprising an anti foam.

### SUMMARY OF THE INVENTION

It is a surprising and unexpected discovery of the present invention that the low-viscosity liquid detergent composition according to the present disclosure can meet the need as above, i.e., the low-viscosity liquid detergent composition according to the present disclosure can deliver both a low-suds performance and a low viscosity.

Particularly, it is surprising that the replacement of a conventional non-ionic surfactant with a new non-ionic surfactant results in a significantly reduced viscosity. Such discovery is totally unexpected because the inventors tested many approaches to reduce the viscosity but failed. For example, solvents commonly used for modifying viscosity did not work in the context of a relatively high level of anti-foam.

Correspondingly, the present invention in one aspect relates to a low-viscosity liquid detergent composition, comprising:

a) from 0.03% to 5% by weight of the composition, of an anti-foam; and

b) from 3% to 30% by weight of the composition, of a non-ionic surfactant which is an alcohol ethoxylate of formula (I):

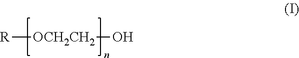

where R is selected from a saturated or unsaturated, linear or branched, C8-C20 alkyl group, where greater than 90% of n is 0≤n≤15, and where the average value of n is between 4-14, wherein less than about 20% by weight of the alcohol ethoxylate are ethoxylates having n<8.

In some embodiments, the alcohol ethoxylate of formula (I) may comprise an average value of n is between 5 and 10.

In some embodiments, the alcohol ethoxylate of formula (I) may comprise between 10% and 20% by weight of the alcohol ethoxylate are ethoxylates having n=8.

In some embodiments, less than about 10% by weight of the alcohol ethoxylate may be ethoxylates having n<7.

In some embodiments, the average n value in formula (I) may be between 8 and 11.

In some embodiments, the alcohol ethoxylate of formula (I) may comprise by between about 30% by weight and about 55% by weight of the alcohol ethoxylates are ethoxylates having n=9-10.

In some embodiments, the alcohol ethoxylate of formula (I) may comprise greater than 80% by weight of the alcohol ethoxylate are ethoxylates having n>7.

In some embodiments, the alcohol ethoxylate may be derived from a natural alcohol, a synthetic alcohol, or a mixture thereof.

Particularly, the non-ionic surfactant suitable in the present application may be present in an amount ranging from 3% to 25%, preferably from 3.5% to 20%, more preferably from 4% to 18%, yet more preferably from 4.5% to 16%, most preferably from 5% to 15%, e.g. 5.5%, 6%, 6.5%, 7%, 8%, 9%, 10%, 12%, 14%, or any ranges therebetween, by weight of the composition.

In some embodiments, the liquid detergent composition may further comprise:

c) from 0.01% to 10%, by weight of the composition, of a crystalline, hydroxyl-containing stabilizing agent.

Particularly, the stabilizing agent suitable in the present application may be present in an amount ranging from 0.01% to 9%, preferably from 0.02% to 8%, more preferably from 0.03% to 5%, yet more preferably from 0.05% to 3%, most preferably from 0.06% to 2%, by weight of the composition. Preferably, the stabilizing agent may be selected from the group consisting of microcrystalline cellulose or derivatives thereof, castor oil or derivatives thereof, hydrogenated castor oil or derivatives thereof, and any combinations thereof. More preferably, the stabilizing agent may be microcrystalline cellulose and/or hydrogenated castor oil.

Particularly, the anti-foam suitable in the present application may be present in an amount ranging from 0.04% to 3%, preferably from 0.08% to 2%, more preferably from 0.1% to 1%, e.g. 0.2%, 0.3%, 0.5%, 0.7%, 1%, 1.5%, 2%, 2.5% or any ranges therebetween, by weight of the composition. Preferably, the anti-foam may comprise silicone, silica or any mixture thereof. More preferably, the anti-foam may comprise polydimethylsiloxane (PDMS).

In some embodiments, the liquid detergent composition may further comprise:

d) from 0.01% to 3%, preferably from 0.01% to 1%, more preferably from 0.02% to 0.5%, most preferably from 0.03% to 0.3%, by weight of the composition, of an anti-microbial agent that is preferably selected from the group consisting of diphenyl ethers and combinations thereof;

e) from 4.5% to 40%, preferably from 5.5% to 30%, more preferably from 6% to 20%, most preferably from 6.5% to 18%, by weight of the composition, of an organic acid that is preferably selected from the group consisting of citric acid, lactic acid, tartaric acid, malic acid and any combinations thereof; and/or

f) from 2% to 35%, preferably from 3% to 30%, more preferably from 4% to 25%, most preferably from 5% to 20%, by weight of the composition of an anionic surfactant that is preferably selected from the group consisting of C₆-C₂₀ linear alkylbenzene sulfonates (LAS), C₆-C₂₀ alkyl sulfates (AS), C₆-C₂₀ alkyl alkoxy sulfates (AAS), C₆-C₂₀ methyl ester sulfonates (MES), C₆-C₂₀ alkyl ether carboxylates (AEC), and any combinations thereof.

In a preferred embodiment, the liquid detergent composition according to the present application may comprise:

a) from 0.1% to 0.5%, by weight of the composition, of an anti-foam in which the anti-foam comprises polydimethylsiloxane (PDMS);

b) from 10% to 15%, by weight of the composition, of an alcohol ethoxylate of formula (I) as shown above;

c) from 0.06% to 2%, by weight of the composition, of a hydrogenated castor oil;

d) from 0.03% to 0.3%, by weight of the composition, of 4-4′-dichloro-2-hydroxy diphenyl ether;

e) from 6.5% to 18%, by weight of the composition, of citric acid; and/or

f) from 5% to 20%, by weight of the composition, of C₆-C₂₀ linear alkylbenzene sulfonates (LAS).

It is an advantage of the liquid detergent composition according to the present disclosure that it can provide both a liquid having low viscosity and a performance of low suds.

### DETAILED DESCRIPTION OF THE INVENTION

### Definitions

As used herein, the articles including “a” and “an” when used in a claim, are understood to mean one or more of what is claimed or described.

As used herein, the terms “comprise”, “comprises”, “comprising”, “include”, “includes”, “including”, “contain”, “contains”, and “containing” are meant to be non-limiting, i.e., other steps and other ingredients which do not affect the end of result can be added. The above terms encompass the terms “consisting of” and “consisting essentially of”.

As used herein, when a composition is “substantially free” of a specific ingredient, it is meant that the composition comprises less than a trace amount, alternatively less than 0.1%, alternatively less than 0.01%, alternatively less than 0.001%, by weight of the composition, of the specific ingredient.

As used herein, the term “liquid detergent composition” herein refers to compositions that are in a form selected from the group consisting of pourable liquid, gel, cream, and combinations thereof. The liquid detergent composition may be either aqueous or non-aqueous, and may be anisotropic, isotropic, or combinations thereof.

As used herein, the term “anti-foam” refers to a chemical compound of which the principle intended function is to depress foaming or suds caused by detergents during the wash. Conventional anti-foams include silicone antifoam compounds, alcohol antifoam compounds, paraffin antifoam compounds and mixtures thereof.

As used herein, the term “anti-microbial agent” refers to a chemical compound of which the principle intended function is to kill bacteria and/or to prevent their growth or reproduction. Traditional anti-microbial agents include cationic anti-microbial agents (e.g., certain ammonium chlorides), nonionic anti-microbial agents, etc. diphenyl ether compounds that are used in the present invention are nonionic anti-microbial agents.

As used herein, the term “main surfactant” refers to a surfactant that is present in a composition at an amount that is greater than any other surfactant contained by such composition.

As used herein, the term “majority surfactant” refers to a surfactant that is present in a composition at an amount that is at least 50% by weight of the total surfactant content in such composition.

As used herein, the term “alkyl” means a hydrocarbyl moiety which is branched or unbranched, substituted or unsubstituted. Included in the term “alkyl” is the alkyl portion of acyl groups.

As used herein, the term “washing solution” refers to the typical amount of aqueous solution used for one cycle of laundry washing, preferably from 1 L to 50 L, alternatively from 1 L to 20 L for hand washing and from 20 L to 50 L for machine washing.

As used herein, the term “soiled fabric” is used non-specifically and may refer to any type of natural or artificial fibers, including natural, artificial, and synthetic fibers, such as, but not limited to, cotton, linen, wool, polyester, nylon, silk, acrylic, and the like, as well as various blends and combinations.

### Antifoam

Suitable antifoams may include, for example, silicone antifoam compounds, alcohol antifoam compounds, paraffin antifoam compounds, and mixtures thereof.

Particularly, preferred antifoam compounds suitable used herein are silicone antifoam compounds comprising a silicone component. Many such silicone antifoam compounds also contain a silica component. The term “silicone” as used herein, and in general throughout the industry, encompasses a variety of relatively high molecular weight polymers containing siloxane units and hydrocarbyl group of various types like the polyorganosiloxane oils, such as polydimethyl-siloxane, dispersions or emulsions of polyorganosiloxane oils or resins, and combinations of polyorganosiloxane with silica particles wherein the polyorganosiloxane is chemisorbed or fused onto the silica. Silica particles are often hydrophobed, e.g. as Trimethylsiloxysilicate. Examples of suitable silicone antifoam compounds Linear polydimethylsiloxane with mono/di glycerides, linear polydimethylsiloxane commercially available from Dow Corning, Wacker Chemie and Momentive.

Other suitable antifoam compounds include, for example, high molecular weight hydrocarbons such as paraffin, light petroleum odorless hydrocarbons, fatty esters (e. g. fatty acid triglycerides, glyceryl derivatives, polysorbates), fatty acid esters of monovalent alcohols, aliphatic C18-C40 ketones (e.g. stearone)N-alkylated amino triazines such as tri- to hexa-10 alkylmelamines or di- to tetra-alkyldiamine chlortriazines formed as products of cyanuric chloride with two or three moles of a primary or secondary amine containing 1 to 24 carbon atoms, propylene oxide, bis stearic acid amide and monostearyl phosphates such as monostearyl alcohol phosphate ester and monostearyl di-alkali metal (e. g., K, Na, and Li) phosphates and phosphate esters, and nonionic polyhydroxyl derivatives.

Other antifoams useful herein comprise the secondary alcohols (e.g., 2-alkyl alkanols as described in DE 40 21 265) and mixtures of such alcohols with silicone oils. The secondary alcohols include the C6-C16 alkyl alcohols having a C1-C16 chain like the 2-Hexyldecanol, 2-Octyldodecanol, and 2-butyl octanol.

### Non-Ionic Surfactant

The composition according to the present disclosure comprises a non-ionic surfactant which has a specific structure. Particularly, the non-ionic surfactant suitably used in the liquid detergent composition according to the present disclosure is an alcohol ethoxylate having the following general formula (I):

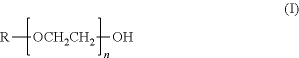

where R is selected from a saturated or unsaturated, linear or branched, C₈-C₂₀ alkyl group and where greater than 90% of n is 0≤n≤15.

The alcohol ethoxylates described herein are typically not single compounds as suggested by their general formula (I), but rather, they comprise a mixture of several homologs having varied polyalkylene oxide chain length and molecular weight. Among the homologs, those with the number of total alkylene oxide units per mole of alcohol closer to the most prevalent alkylene oxide adduct are desirable; homologs whose number of total alkylene oxide units is much lower or much higher than the most prevalent alkylene oxide adduct are less desirable. In other words, a “narrow range” or “peaked” alkoxylated alcohol composition is desirable. A “narrow range” or “peaked” alkoxylated alcohol composition refers to an alkoxylated alcohol composition having a narrow distribution of alkylene oxide addition moles.

A “narrow range” or “peaked” alkoxylated alcohol composition may be desirable for a selected application. Homologs in the selected target distribution range may have the proper lipophilic-hydrophilic balance for a selected application. For example, in the case of an ethoxylated alcohol product comprising an average ratio of 5 ethylene oxide (EO) units per molecule, homologs having a desired lipophilic-hydrophilic balance may range from 2EO to 9EO.

The alkoxylated alcohol compositions of the present disclosure may have an average degree of ethoxylation ranging from about 0 to about 15, such as, for example, ranging from about 4 to about 14, from about 5-10, from about 8-11, and from about 6-9. The alkoxylated alcohol compositions of the present disclosure may have an average degree of ethoxylation of 11, 10, 9, 8, 7, 6 or 5. In some preferred embodiments, the alkoxylated alcohol compositions of the present disclosure may have an average degree of ethoxylation of at least 8 or 9.

The present disclosure attempts to solve one more of the needs by providing a composition comprising an alcohol ethoxylate of formula (I):

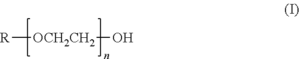

where R is selected from a saturated or unsaturated, linear or branched, C₈-C₂₀ alkyl group, where greater than 90% of n is 0≤n≤15, and where the average value of n between about 6 to about 10, where less than about 10% by weight of the alcohol ethoxylate are ethoxylates having n<7 and between about 10% and about 20% by weight of the alcohol ethoxylate are ethoxylates having n=8.

The composition may comprise an average value of n of about 10. The composition may have the following ranges for each of the following n:

N=0 of up to 5%, each of n=1, 2, 3, 4, 5 of up to 2%, n=6 of up to 4%, n=7 of up to 10%, n=8 of between 12% and 20%, n=9 of between 15% and 25%, n=10 of between 15% to 30%, n=11 of between 10% and 20%, n=12 of up to 10%, and n>12 at up to 10%. The composition may have n=9 to 10 of between 30% and 70%. The composition may have greater than 50% of its composition made up of n=8 to 11.

The ranges described above are exemplified in Table 1. As shown below in Table 1, normal range non-ionic surfactant and narrow range non-ionic surfactant samples were analyzed by LCMS ESI (−) after derivatization with DMF-SO₃ complex as well as by LCMS ESI (+). % Relative abundances are listed below in the table. Percent Relative Abundance is the weighted average of each ethoxymer relative to the total abundance of all ethoxymers in the sample.

TABLE 1
Comparative distribution of EO numbers in exemplary
normal range and narrow range non-ionic surfactants

| Moles | Normal range | Narrow range |
|---|---|---|
| of EO | C12-14EO9 | C12-14EO9 |
| 0 | 3.14% | 2.33% |
| 1 | 1.26% | 0% |
| 2 | 1.55% | 0% |
| 3 | 2.20% | 0% |
| 4 | 3.08% | 0.39% |
| 5 | 4% | 0.940% |
| 6 | 5.21% | 2.93% |
| 7 | 6.58% | 7.90% |
| 8 | 8.10% | 15.96% |
| 9 | 9.41% | 21.56% |
| 10 | 9.78% | 21.27% |
| 11 | 9.51% | 15.19% |
| 12 | 8.58% | 7.64% |
| 13 | 7.35% | 2.84% |
| 14 | 5.98% | 0.88% |
| 15 | 4.65% | 0.18% |
| 16 | 3.46% | 0% |
| 17 | 2.48% | 0% |
| 18 | 1.74% | 0% |
| 19 | 1.17% | 0% |
| 20 | 0.75% | 0% |

Please note that LCMS-ESI (+) is not sensitive to ethoxymers of less than 3 moles, nor free alcohol. In addition, ethoxymers between 3-5 moles are underrepresented. Typically, if the average distribution of EO is greater than 7 moles of EO, the distribution is not greatly affected by this limit of sensitivity. Additionally, LCMS-ESI (−) can underrepresent heavier ethoxymers when the distribution is very wide, as in normal range non-ionic surfactant samples. For this reason, the normal range non-ionic surfactant sample was analyzed in both +/− modes and the average was taken.

Catalyst and Process of Making Narrow Range Alcohol Alkoxylates

The alkoxylation catalysts described herein allow for the preparation of alcohol alkoxylates having a narrow distribution of alkylene oxide addition moles. It is believed that, in a conventional base-catalyzed alkoxylation reaction, for example, a KOH-catalyzed alcohol ethoxylation reaction, there is a tendency for ethylene oxide to react with alcohol ethoxylate conjugates (alcohol ethoxylate conjugates are more acidic), rather than to react with unreacted alcohol conjugates, thereby yielding a broad range distribution having greater percentages of free alcohol and high-degree ethoxylated alcohols.

The alkoxylation catalysts described herein have a number of advantages for commercial manufacturing compared with known catalysts that provide narrow distribution alkoxylates. The alkoxylation catalysts described herein comprise conventionally used, low-cost raw materials, and the catalysts may be readily prepared. The alkoxylation catalysts described herein are also stable and, therefore, readily handled. Also, the reaction rate, using the alkoxylation catalysts described herein, is similar to previously used alkaline catalysts and suitable for commercial production.

The alkoxylation catalysts described herein are suitable for alkoxylating natural or synthetic, linear or branched, saturated or unsaturated, C8-20 alcohols, alkyl phenols, polyols, etc. having 4-22 carbon atoms. Suitable alcohols include pure linear materials (naturals), lightly branched in C2 position (Neodols®), lightly random-branched (Safols®), highly branched in C2 position (Isalchem®), and highly branched mid-chain materials (HSA). Suitable synthetic alcohols include those sold by Shell Chemical Company under the trademark Neodol®, including Neodol® 25, Neodol® 23, Neodol® 45 and Neodol® 5. Suitable natural alcohols include C1214. In addition, known reaction procedures, reaction conditions, and reactors for alkylene oxides may be used with the alkoxylation catalyst described herein.

The alkoxylation processes described herein may also be run in a series, initially using the acid catalyst described herein and then using a conventional, known catalyst, such as KOH, to yield alkoxylates having a distribution of alkylene oxide addition moles that is narrower than that produced by KOH catalyst alone but broader than that produced by the catalysts of the invention alone. Running the alkoxylation process in series may be particularly useful for higher ethoxylation degree targets, e.g., EO4, EO5, EO6.

The alkoxylation reaction itself may be performed in a single pot or in a continuous process. The ethylene oxide (EO) may initially be reacted with the catalyst, which activates EO to nucleophilic attack. Continuous plant processes with suitable residence time may be used.

The alkoxylation processes disclosed herein may be used to produce alcohol ethoxylates of varying degrees of ethoxylation, including the EO1, EO2, and EO3 targets that are specifically called out. The alkoxylation processes disclosed herein may be also be used to produce other alcohol alkoxylates, e.g., propoxylated alcohol, of varying degress of alkoxylation.

A suitable method for preparing an ethoxylated alcohol as disclosed herein includes the steps of: i) reacting an excess (for example, from about 0% to about 5% excess) of ethylene oxide with a linear or branched, C8-C20 alcohol for stoichiometric target mole ratio of ethylene oxide, in the presence of about 1% to about 10% of a Novel or G2 catalyst.

### Other Surfactants

The composition according to the present disclosure may comprise an additional surfactant comprising an anionic surfactant, a cationic surfactant, an amphoteric surfactant and any combinations thereof.

The anionic surfactant suitable for the composition in the present invention may be selected from the group consisting of C₆-C₂₀ linear alkylbenzene sulfonates (LAS), C₆-C₂₀ alkyl sulfates (AS), C₆-C₂₀ alkyl alkoxy sulfates (AAS), C₆-C₂₀ methyl ester sulfonates (MES), C₆-C₂₀ alkyl ether carboxylates (AEC), and any combinations thereof. For example, the laundry detergent composition may contain a C₆-C₂₀ alkyl alkoxy sulfates (AAₓS), wherein x is about 1-30, preferably about 1-15, more preferably about 1-10, most preferably x is about 1-3. The alkyl chain in such AAₓS can be either linear or branched, with mid-chain branched AAₓS surfactants being particularly preferred. A preferred group of AAₓS include C₁₂-C₁₄ alkyl alkoxy sulfates with x of about 1-3. In some embodiments, the composition comprises from 1% to 30%, preferably from 2% to 25%, more preferably from 3% to 20%, for example, 4%, 5%, 6%, 7%, 8%, 9%, 10%, 12%, 14%, 16%, 18%, 20%, or any ranges therebetween, by weight of the composition of the anionic surfactant.

The ratio of the anionic surfactant to the nonionic surfactant may be between 0.01 and 100, preferably between 0.05 and 20, more preferably between 0.1 and 10, and most preferably between 0.2 and 5.

In some embodiments, the anionic surfactant comprises a C₆-C₂₀ linear alkylbenzene sulfonate surfactant (LAS), preferably C₁₀-C₁₆ LAS, and more preferably C₁₂-C₁₄ LAS.

In some particular embodiments of the present invention, the anionic surfactant may be present as the main surfactant, preferably as the majority surfactant, in the composition. Preferably, the ratio of anionic surfactant to nonionic surfactant may be between 1.05 and 100, preferably between 1.1 and 20, more preferably between 1.2 and 10, and most preferably between 1.3 and 5. Particularly, the anionic surfactant may comprise C₆-C₂₀ linear alkylbenzene sulfonates (LAS).

In some particular embodiments of the present invention, the nonionic surfactant may be present as the main surfactant, preferably as the majority surfactant, in the composition. Preferably, the ratio of anionic surfactant to nonionic surfactant may be between 0.01 and 0.95, preferably between 0.05 and 0.9, more preferably between 0.1 and 0.85, and most preferably between 0.2 and 0.8.

The laundry detergent composition of the present invention may further comprise a cationic surfactant. Non-limiting examples of cationic surfactants include: quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; and amino surfactants, specifically amido propyldimethyl amine (APA).

The laundry detergent composition of the present invention may further comprise another amphoteric surfactant (i.e., besides AO). Non-limiting examples of other amphoteric surfactants include: derivatives of secondary and tertiary amines, derivatives of heterocyclic secondary and tertiary amines, or derivatives of quaternary ammonium, quaternary phosphonium or tertiary sulfonium compounds. Preferred examples include: betaine, including alkyl dimethyl betaine and cocodimethyl amidopropyl betaine, sulfo and hydroxy betaines, such as N-alkyl-N,N-dimethylammino-1-propane sulfonate where the alkyl group can be C₈-C₁₈ or C₁₀-C₁₄.

### Stabilizing Agent

The stabilizing agent suitable for use in the present invention may be a crystalline, hydroxyl-containing stabilizing agent.

Preferably, the stabilizing agent may be selected from the group consisting of microcrystalline cellulose (MCC) or derivatives thereof, castor oil or derivatives thereof, hydrogenated castor oil (HCO) or derivatives thereof, and any combinations thereof. More preferably, the stabilizing agent may be microcrystalline cellulose or derivatives thereof and/or hydrogenated castor oil or derivatives thereof.

MCC is a naturally occurring polymer. It is composed of glucose units connected by a 1-4 beta glycosidic bond. These linear cellulose chains are bundled together as microfibril spiralled together in plant cell walls. It has been used in food applications and pharmaceutical tablets.

Castor oils may include glycerides, especially triglycerides, comprising C₁₀ to C₂₂ alkyl or alkenyl moieties which incorporate a hydroxyl group. Hydrogenation of castor oil to make HCO converts double bonds, which may be present in the starting oil as ricinoleyl moieties, to convert ricinoleyl moieties to saturated hydroxyalkyl moieties, e.g., hydroxystearyl. The HCO herein may, in some embodiments, be selected from: trihydroxystearin; dihydroxystearin; and mixtures thereof. The HCO may be processed in any suitable starting form, including, but not limited those selected from solid, molten and mixtures thereof.

In some preferred embodiments, the stabilizing agent is incorporated into the liquid detergent composition through the use of external structuring system(s) (ESS) comprising the stabilizing agent. The ESS suitable for use in the present invention may comprise: (a) the stabilizing agent; (b) alkanolamine e.g. monoethanolamine (MEA); (c) anionic surfactant such as: linear alkyl benzene sulphonate (LAS); and (d) additional components.

HCO is typically present in the ESS of the present invention at a level of from about 2% to about 10%, from about 3% to about 8%, or from about 4% to about 6% by weight of the structuring system. In some embodiments, the corresponding percentage of hydrogenated castor oil delivered into a finished laundry detergent product is below about 1.0%, typically from 0.1% to 0.8%.

Useful HCO may have the following characteristics: a melting point of from about 40° C. to about 100° C., or from about 65° C. to about 95° C.; and/or Iodine value ranges of from 0 to about 5, from 0 to about 4, or from 0 to about 2.6. The melting point of HCO can be measured using either ASTM D3418 or ISO 11357; both tests utilize DSC: Differential Scanning calorimetry.

HCO of use in the present invention includes those that are commercially available. Non-limiting examples of commercially available HCO of use in the present invention include: THIXCIN® from Rheox, Inc. The source of the castor oil for hydrogenation to form HCO can be of any suitable origin, such as from Brazil or India. In one suitable embodiment, castor oil is hydrogenated using a precious metal, e.g., palladium catalyst, and the hydrogenation temperature and pressure are controlled to optimize hydrogenation of the double bonds of the native castor oil while avoiding unacceptable levels of dehydroxylation.

The stabilizing agent in the composition according to the present disclosure may be present in an amount ranging from 0.01% to 9%, preferably from 0.02% to 8%, more preferably from 0.03% to 5%, yet more preferably from 0.05% to 3%, most preferably from 0.06% to 2%, for example, 0.1%, 0.2%, 0.3%, 0.5%, 0.7%, 1%, 2% or any ranges therebetween, by weight of the composition.

### Anti-Microbial Agent

Suitable anti-microbial agent used in the present invention may be a diphenyl ether-based anti-microbial agent. Preferably, the anti-microbial agent is a hydroxyl diphenyl ether. The anti-microbial agent herein can be either halogenated or non-halogenated, but preferably is halogenated. In one embodiment, the anti-microbial agent is a hydroxyl diphenyl ether of formula (I):

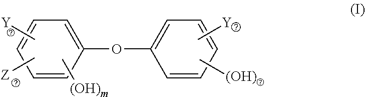

wherein:
each Y is independently selected from chlorine, bromine, or fluorine, preferably is chlorine or bromine, more preferably is chlorine, each Z is independently selected from SO₂H, NO₂, or C₁-C₄ alkyl,
r is 0, 1, 2, or 3, preferably is 1 or 2,
o is 0, 1, 2, or 3, preferably is 0, 1 or 2,
p is 0, 1, or 2, preferably is 0,
m is 1 or 2, preferably is 1, and
n is 0 or 1, preferably is 0.

In the above definition for formula (I), 0 means nil. For example, when p is 0, then there is no Z in formula (I). Each Y and each Z could be the same or different. In one embodiment, o is 1, r is 2, and Y is chlorine or bromine. This embodiment could be: one chlorine atom bonds to a benzene ring while the bromine atom and the other chlorine atom bond to the other benzene ring; or the bromine atom bonds to a benzene ring while the two chlorine atoms bond to the other benzene ring.

More Preferably, the anti-microbial agent is selected from the group consisting of 4-4′-dichloro-2-hydroxy diphenyl ether (“Diclosan”), 2,4,4′-trichloro-2′-hydroxy diphenyl ether (“Triclosan”), and a combination thereof. Most preferably, the anti-microbial agent is 4-4′-dichloro-2-hydroxy diphenyl ether, commercially available from BASF, under the trademark name Tinosan®HP100.

In addition to the diphenyl ether, other anti-microbial agents may also be present, provided that these are not present at a level which causes instability in the formulation. Among such useful further antimicrobial agents are chelating agents, which are particularly useful in reducing the resistance of Gram negative microbes in hard water. Acid biocides may also be present.

### Polyamine

The laundry detergent composition herein may further comprise from 0.1% to 10%, preferably from 0.5% to 5%, by weight of the composition of a polyamine, preferably a polyethyleneimine, more preferably an alkoxylated polyethyleneimine.

The polyamine suitable for the laundry detergent composition herein may be of Mw higher than 400 g/mol. A preferred class of polyamines is polyethyleneimines (PEIs) and derivatives thereof such as ethoxylated PEI polymers, propoxylated PEI polymers, polyamines, polyquats, polyglycerol quats, and other PEI derivatives, their salts or mixtures thereof. In some preferred embodiments, the PEIs are branched, spherical polymeric amines, and the molecular weight of the PEI or PEI salt used is from about 800 daltons to about 2 million Daltons. In addition, in some preferred embodiments, the charge density of the PEI or PEI salt used is from about 15 meq/g to about 25 meq/g, more preferably from about 16 meq/g to about 20 meq/g. Examples of such preferred PEIs include the BASF products LUPASOL WF (25 kDa; 16-20 meq/g) and Lupasol® FG (800 daltons; 16-20 meq/g), and the SOKALAN® family of polymers available from BASF, e.g., SOKALAN® HP20, and SOKALAN® HP22 G.

### Adjunct Ingredients

The laundry detergent composition herein may comprise adjunct ingredients. Suitable adjunct materials include but are not limited to: builders, chelating agents, rheology modifiers, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, photobleaches, perfumes, perfume microcapsules, structure elasticizing agents, fabric softeners, carriers, hydrotropes, processing aids, solvents, hueing agents, structurants and/or pigments. The precise nature of these adjunct ingredients and the levels thereof in the laundry detergent composition will depend on the physical form of the composition and the nature of the cleaning operation for which it is to be used.

In one embodiment, the composition herein comprises a rheology modifier (also referred to as a “structurant” in certain situations), which functions to adjust the viscosity of the composition so as to be more applicable to the packaging assembly. The rheology modifier herein can be any known ingredient that is capable of suspending particles and/or adjusting rheology to a liquid composition. Preferably the rheology modifier is selected from the group consisting of hydroxy-containing crystalline material, polyacrylate, polysaccharide, polycarboxylate, alkali metal salt, alkaline earth metal salt, ammonium salt, alkanolammonium salt, C₁₂-C₂₀ fatty alcohol, di-benzylidene polyol acetal derivative (DBPA), di-amido gallant, a cationic polymer comprising a first structural unit derived from methacrylamide and a second structural unit derived from diallyl dimethyl ammonium chloride, and a combination thereof. Preferably, the rheology modifier is a hydroxy-containing crystalline material generally characterized as crystalline, hydroxyl-containing fatty acids, fatty esters and fatty waxes, such as castor oil and castor oil derivatives. More preferably the rheology modifier is a hydrogenated castor oil (HCO).

In one embodiment, the composition may further comprise from 0.1% to 5%, preferably from 0.2% to 2%, by weight of the composition of a chelating agent, preferably diethylene triamine penta-acetic acid (DTPA) and/or glutamic acid diacetate (GLDA).

### Composition Preparation

The laundry detergent composition of the present invention is generally prepared by conventional methods such as those known in the art of making laundry detergent compositions. Such methods typically involve mixing the essential and optional ingredients in any desired order to a relatively uniform state, with or without heating, cooling, application of vacuum, and the like, thereby providing laundry detergent compositions containing ingredients in the requisite concentrations.

### Test Method

### Test 1: Viscosity Test

All viscosities stated herein are measured at 60 rpm with spindle #62 and at a temperature of 20+/−1° C. Viscosities can be measured with any suitable viscosity-measuring instrument, e.g., LVDVII+, RVDVII or Brookfield instruments.

### Test 2: Suds Performance Test

Suds performance test is conducted either in a laundry washing machine or in a simulated washing instrumental like a foam cylinder test set. The washing machine test procedure is as below:
1) Connect water flow meter between washing machine (WM) and tub. WM is automatic front-loading washing machine or top loading washing machine.
2) Adjust water temperature at 35° C.±1° C.
3) Put the ballast into wash tub. Ballast is composited with clean cotton pants, polycotton pants, clean dress shirt, clean knit shirt, worn T-shirt, and ABS T-shirts. Ballast size is from 1 kg to 5 kg depending on washing machine size.
4) Add detergent into dispenser. Detergent amount can be 10 g to 100 g depending on the ballast size and washing machine size.
5) Start the WM to conduct wash, rinse and spinning.
6) Record the suds height, take picture at end of the wash (just before draining) and check whether there is draining during main-wash.
7) Record suds height and take picture at end of the rinse. Record total times of rinse and total amount of time and total amount of water.
8) Assess the risk based on suds height, suds picture, draining during wash and rinse time.

### Test 3: Stability Test

Stability test is conducted through visual inspection as below:
1) Prepare liquid composition samples to be tested by mixing ingredients in 30 ml transparent glass bottles;
2) Store the samples prepared in Step 1) under different temperatures (5° C. or 40° C.) for a certain period (1, 2 or 4 weeks) or subject the samples prepared in Step 1) to Frozen/Thawed (−18° C. and 15° C.) cycles (1, 2 or 3 cycles) by freezing the samples in refrigerators (at −18° C.) for 24 hours and then thawing the samples in containers (at 15° C.) for 24 hours (repeated if more than 1 cycle);
3) Visually inspect the samples to determine if they are still homogeneous systems after Step 2). If there is any phase separation such as the formation of separated layers or flocculation, it is determined as “fail”. If there is no phase separation, it is determined as “pass”.

### Examples

### Example 1: Comparative Test Showing Increased Viscosity Caused by Introduction of Antifoam

Six (6) sample liquid laundry detergent compositions were prepared containing the ingredients as shown in Table 2 below, in which Sample 1 does not contain an antifoam and Samples 2 to 6 comprise an antifoam and also a stabilizing agent which helps to stabilize the liquid containing the antifoam. Further, Samples 3 to 6 comprise various ingredients which are commonly used for reducing viscosity of the liquid system.

The viscosity (HS) of Samples 1 to 6 were determined by using Brookfield instrument according to Test 1 as described above. The results as shown in Table 2 indicate that the introduction of antifoam in the liquid detergent composition in the present application results in a significantly increased viscosity and the ingredients which are commonly used for reducing viscosity cannot reduce the viscosity to a desirable level.

TABLE 2

| Ingredients | | | | | | |
|---|---|---|---|---|---|---|
| (wt %) | 1 | 2 | 3 | 4 | 5 | 6 |
| Antifoam ^{a} | 0 | 0.2 | 0.2 | 0.2 | 0.2 | 0.2 |
| Non-ionic | 12.2 | 12.2 | 12.2 | 12.2 | 12.2 | 12.2 |
| surfactant ^{b} | | | | | | |
| Anionic | 6.5 | 6.5 | 6.5 | 6.5 | 6.5 | 6.5 |
| surfactant ^{c} | | | | | | |
| Citric acid | 14 | 14 | 14 | 14 | 14 | 14 |
| Stabilizing | 0 | 0.12 | 0.12 | 0.10 | 0.10 | 0.10 |
| agent ^{d} | | | | | | |
| 1,2- | 1.31 | 1.31 | 3 | 1.31 | 1.31 | 1.31 |
| propanediol | | | | | | |
| Na-CS ^{e} | 0 | 0 | 0 | 3 | 0 | 0 |
| Ethanol | 0 | 0 | 0 | 0 | 3 | 0 |
| PEI | 2.81 | 2.81 | 2.81 | 2.81 | 2.81 | 2.81 |
| polymer ^{f} | | | | | | |
| Tinosan ® | 0.05 | 0.05 | 0.05 | 0.05 | 0.05 | 0.05 |
| HP100 | | | | | | |
| Brightener ^{g} | 0.1 | 0.1 | 0.1 | 0.1 | 0.1 | 0.1 |
| Water | Balance | Balance | Balance | Balance | Balance | Balance |
| HS | 199 | 322 | 317 | 296 | 277 | 324 |
| Viscosity, | | | | | | |
| cps | | | | | | |
| Note | No | Anti- | Anti- | Anti- | Anti- | Anti- |
| | Anti- | foam | foam + | foam + | foam + | foam + |
| | foam | | High | NaCS | Ethanol | High PEI |
| | | | p-diol | | | |

^{a} Antifoam material which is a mixture comprising polydimethylsilicone (PDMS), silica, polyether modified polydimethysiloxane and polyether, available from SIXIN (Jiangsu SIXIN Scientific Technological Application Research Institute Co., Ltd.)
^{b} Neodol ®25-7 which is C₁₂-C₁₅ alcohol ethoxylated with an average of 7 moles of ethylene oxide as a nonionic surfactant, available from Shell
^{c} C₁₁₋₁₃LAS
^{d} HCO available from Nidera BV
^{e} Sodium cumene sulphonate
^{f} Polyethyleneimines (PEI) polymer ethoxylated or ethoxylated and propoxylated, available from BASF
^{g} A solution of Brightener 49 in a non-ionic surfactant available from BASF. The solution of Brightener 49 contains 7.56 wt % of Brightener 49 and 39.5% C₁₂-C₁₅ alcohol ethoxylated with an average of 7 moles of ethylene oxide (i.e. natural range EO7). As such, the addition of 0.1% Brightener 49 will also introduce 0.52% of natural EO7.

### Example 2: Comparative Test Showing Significantly Decreased Viscosity by Replacing Conventional Non-Ionic Surfactant with Preferred Non-Ionic Surfactant

Four (4) sample liquid laundry detergent compositions were prepared containing the ingredients as shown in Table 3 below, in which Samples 7 to 10 contain the same ingredients except different non-ionic surfactants. Particularly, Sample 7 contains 12.7% non-ionic surfactant with a natural range of EO7, Sample 8 contains 6.35% non-ionic surfactant with a natural range of EO7 and 6.35% non-ionic surfactant with a natural range of EO9, Sample 9 contains 12.7% non-ionic surfactant with a natural range of EO9, and Sample 10 contains 12.7% non-ionic surfactant with a narrow range of EO9.

The viscosity (HS) of Samples 7 to 10 were determined by using Brookfield instrument according to Test 1 as described above. The results as shown in Table 3 indicate that the replacement of the conventional non-ionic surfactant (natural EO7) in the liquid detergent composition of the present application with a preferred non-ionic surfactant results in a significantly decreased viscosity which is desirable for consumers. Particularly, the natural EO9 shows a better performance in the aspect of viscosity compared to the natural EO7, and the narrow EO9 shows an even better performance compared to the natural EO9.

TABLE 3

| Ingredients | | | | |
|---|---|---|---|---|
| (wt %) | 7 | 8 | 9 | 10 |
| Antifoam^{a} | 0.2 | 0.2 | 0.2 | 0.2 |
| Non-ionic | 12.7 | 6.6 | — | — |
| surfactant 1^{b} | | | | |
| Non-ionic | — | 6.1 | 12.7 | — |
| surfactant 2^{c} | | | | |
| Non-ionic | — | — | — | 12.7 |
| surfactant 2^{d} | | | | |
| Anionic | 6.5 | 6.5 | 6.5 | 6.5 |
| surfactant^{e} | | | | |
| Citric acid | 10 | 10 | 10 | 10 |
| Stabilizing agent^{f} | 0.08 | 0.08 | 0.08 | 0.08 |
| 1,2-propanediol | 1.31 | 1.31 | 1.31 | 1.31 |
| PEI polymer^{g} | 2.81 | 2.81 | 2.81 | 2.81 |
| Tinosan ® | 0.05 | 0.05 | 0.05 | 0.05 |
| HP100 | | | | |
| Brightener^{h} | 0.1 | 0.1 | 0.1 | 0.1 |
| Water | Balance | Balance | Balance | Balance |
| HS Viscosity, | 246.5 | 202.0 | 175.5 | 148.5 |
| cps | | | | |
| Note | Natural | Natural | Natural | Narrow |
| | EO7 | EO7/ | EO9 | EO9 |
| | | Natural | | |
| | | EO9 | | |

^{a}Antifoam material which is a mixture comprising polydimethylsilicone (PDMS), silica, polyether modified polydimethysiloxane and polyether, available from SIXIN (Jiangsu SIXIN Scientific Technological Application Research Institute Co., Ltd.)
^{b}Neodol ® 25-7 which is C₁₂-C₁₅ alcohol ethoxylated with an average of 7 moles of ethylene oxide as a nonionic surfactant, available from Shell
^{c}Neodol ® 25-9 which is C₁₂-C₁₅ alcohol ethoxylated with an average of 9 moles of ethylene oxide as a nonionic surfactant, available from Shell
^{d}Ziegler NI EO9 which is narrow range C₁₂-C₁₅ alcohol ethoxylated with an average of 9 moles of ethylene oxide as a nonionic surfactant, available from Shell
^{e}C₁₁-₁₃LAS
^{f}HCO available from Nidera BV
^{g}Polyethyleneimines (PEI) polymer ethoxylated or ethoxylated and propoxylated, available from BASF
^{h}A solution of Brightener 49 in a non-ionic surfactant available from BASF. The solution of Brightener 49 contains 7.56 wt % of Brightener 49 and 39.5% C₁₂-C₁₅ alcohol ethoxylated with an average of 7 moles of ethylene oxide (i.e. natural range EO7). As such, the addition of 0.1% Brightener 49 will also introduce 0.52% of natural EO7.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid detergent composition, comprising:
a) from 0.03% to 5% by weight of the composition, of an anti-foam; and
b) from 3% to 30% by weight of the composition, of a non-ionic surfactant which is an alcohol ethoxylate of formula (I): 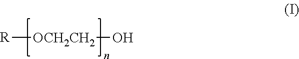
where R is selected from a saturated or unsaturated, linear or branched, C₈-C₂₀ alkyl group, where greater than 90% of n is 0≤n≤15, and where the average value of n is between 4-14, wherein less than about 20% by weight of the alcohol ethoxylate are ethoxylates having n<8.

2. The liquid detergent composition of claim 1, wherein the alcohol ethoxylate of formula (I) comprises an average value of n is between 5 and 10.

3. The liquid detergent composition of claim 1, wherein the alcohol ethoxylate of formula (I) comprises between 10% and 20% by weight of the alcohol ethoxylate are ethoxylates having n=8.

4. The liquid detergent composition of claim 1, wherein the alcohol ethoxylate of formula (I) wherein less than about 10% by weight of the alcohol ethoxylate are ethoxylates having n<7.

5. The liquid detergent composition of claim 1, wherein the alcohol ethoxylate of formula (I) wherein the average n value is between 8 and 11.

6. The liquid detergent composition of claim 1, wherein the alcohol ethoxylate of formula (I) comprises by between about 30% by weight and about 55% by weight of the alcohol ethoxylates are ethoxylates having n=9-10.

7. The liquid detergent composition of claim 1, wherein the alcohol ethoxylate of formula (I) comprises greater than 80% by weight of the alcohol ethoxylate are ethoxylates having n>7.

8. The liquid detergent composition of claim 1, wherein said alcohol ethoxylate is derived from a natural alcohol, a synthetic alcohol, or a mixture thereof.

9. The liquid detergent composition of claim 1, wherein said non-ionic surfactant is present in an amount ranging from 3% to 25%, by weight of the composition.

10. The liquid detergent composition of claim 1, wherein said non-ionic surfactant is present in an amount of about 4% to about 18%, by weight of the composition.

11. The liquid detergent composition of claim 1, wherein said non-ionic surfactant is present in an amount of about 5% to about 15%, by weight of the composition.

12. The liquid detergent composition of claim 11, wherein the liquid detergent composition further comprises:
from 0.01% to 10%, by weight of the composition, of a crystalline, hydroxyl-containing stabilizing agent.

13. The liquid detergent composition of claim 12, wherein said stabilizing agent is present in an amount ranging of about 0.01% to about 9%, by weight of the composition.

14. The liquid detergent composition of claim 13, wherein said stabilizing agent comprises a microcrystalline cellulose; a castor oil; a hydrogenated castor oil; or a combination thereof.

15. The liquid detergent composition of claim 14, wherein said anti-foam is present in an amount of about 0.04% to about 3%, by weight of the composition.

16. The liquid detergent composition of claim 15, wherein the anti-foam comprises silicone, silica, or a mixture thereof.

17. The liquid detergent composition of claim 16, wherein the anti-foam comprises polydimethylsiloxane.

18. The liquid detergent composition of claim 12, wherein the liquid detergent composition further comprises:
from about 0.01% to about 3%, by weight of the composition, of an anti-microbial agent comprising a diphenyl ether; and/or
from about 4.5% to about 40%, by weight of the composition, of an organic acid comprising acid, lactic acid, tartaric acid, malic acid, or a combination thereof and/or from about 2% to about 35%, by weight of the composition of an anionic surfactant comprising a C₆-C₂₀ linear alkylbenzene sulfonate, a C₆-C₂₀ alkyl sulfates, a C₆-C₂₀ alkyl alkoxy sulfates, a C₆-C₂₀ methyl ester sulfonates, a C₆-C₂₀ alkyl ether carboxylates (AEC), or a combination thereof.

19. The liquid detergent composition of claim 1, wherein the composition comprises:
a) from about 0.1% to about 0.5%, by weight of the composition, of the anti-foam in which the anti-foam comprises polydimethylsiloxane;
b) from about 10% to about 15%, by weight of the composition, of the alcohol ethoxylate of formula (I);
c) from about 0.06% to about 2%, by weight of the composition, of hydrogenated castor oil;
d) from about 0.03% to about 0.3%, by weight of the composition, of 4-4′-dichloro-2-hydroxy diphenyl ether; and
e) from about 6.5% to about 18%, by weight of the composition, of citric acid;

20. The liquid detergent composition of claim 19, wherein the composition further composition from about 5% to about 20%, by weight of the composition, of a C₆-C₂₀ linear alkylbenzene sulfonate.
